(19) United States
(12) Patent Application Publication
(10) Pub. No.: US 2003/0128934 A1
(43) Pub. Date: Jul. 10, 2003

(54) Dynamic optical coupling device

(75) Inventors: Shyh-Lin Tsao, Taipei (TW); Wen-Ming Cheng, Taipei (TW); Pin-Chun Lin, Taipei (TW); Chin-Jen Leu, Taipei (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Walsin Lihwa Corporation, Taipei (TW)

(21) Appl. No.: 10/217,210

(22) Filed: Aug. 12, 2002

(30) Foreign Application Priority Data
Jan. 7, 2002 (TW) 091100117

(51) Int. Cl. G02B 6/26

(52) U.S. Cl. 385/52; 385/25

(57) ABSTRACT

A dynamic optical coupling device for coupling an optical signal from a static optical fiber to a dynamic optical fiber is provided. The device includes: a static element for inputting the optical signal, a static ferrule adaptor for mounting the static element therein to pass therethrough, a dynamic element for outputting the optical signal, a dynamic ferrule adaptor for mounting the dynamic ferrule element therein to pass therethrough, wherein a free space is formed between the static ferrule adaptor and the dynamic ferrule adaptor, a ferrule adaptor connector for connecting the static ferrule adaptor and the dynamic ferrule adaptor, and a supporting frame mounting the ferrule adaptor connector therein.

### FIELD OF THE INVENTION

The present invention is related to a dynamic optical coupling device used in a free space, and more particularly, to a dynamic optical coupling device which is suitably used in the on-line automatic examination device of the optical fiber.

### BACKGROUND OF THE INVENTION

Nowadays, due to the needs of the quality control, the manufacture automation, and the reducing of manpower cost, the research emphasis and the direction in the field of optical fiber communication have gradually turned into the industry of automatic manufacturing from the industry of manpower requirement. In order to develop toward the manufacture automation, the problem of light coupling alignment between the active light source and passive element/module must be solved in the first place. Therefore, how to develop a convenient and efficient device for light coupling alignment will be the key factor to manufacture the element of optical fiber communication in an automation system. Even though the experts in the field of optical fiber communication have developed many techniques and methods to improve the transmitting speed and distance, the method or technique with the feature of completeness, convenience and high re-productivity, has not been brought up so far. Especially with the respect of how to couple the light into the dynamic and moving optical fiber and then read the optical signal from the dynamic optical fiber, there is very few theory been mentioned. The technique right now mostly focuses on the application of static coupling, besides, the material and the technique they use are complex and hard to understand. The idea is usually not feasible because of the low re-productivity, the inconvenience, and the economical reason.

In the published paper entitled “Optical characteristics and reliability of plastic split alignment sleeves for single-mode optical fiber connectors” by Shuto et al. (1999, IEEE J. Selected Topics in Quantum Electronics (5): 1418-1425.), the technique of heating and hardening the resin by plastic splitting was proposed, which accomplished the accurate aligning sleeve of single-mode optical fiber connector. By combining the SC-type adaptor and the accurate aligning sleeve, not only the coupling loss is reduced, but also the vibration tolerance is increased. Moreover, the operation of the long and short cycles are maintained in a good reliability. However, even though it does a good job in controlling the feature of optical fiber connection, the connection of the rotational optical fiber is not discussed.

In the published paper entitled “Electromagnetic torsion mirrors for self-aligned fiber-optic cross connectors by silicon micromachining” by Toshiyoshi et al. (1999, IEEE J. Selected Topics in Quantum Electronics (5): 10-17.), the technique of mirror torsion by micromachining was proposed, which accomplished the free space light coupling, the cross connection, and the function of self-alignment. The technique possesses an excellent function so that it is known that the free space light coupling is practical. Nevertheless, the optical fiber coupling in this paper is static and fixed, which is different from the rotational optical fiber in the present invention.

In the published paper entitled “Direct single-mode fiber to free space coupling assisted by a cladding mode” by Erdogan et al. (1999, OFC/IOOC'99. Technical Digest (4): 171-173.), the assistance of cladding mode by single-mode fiber was proposed, which accomplished the technique of free space light transmitting. The fiber axis region is changed through the phase adjustment by the long-cycled optical fiber and grating so that the free space light coupling is easier to achieve. This paper also proves that free space light coupling is commercially needed. In fact, the technique is able to combine with the invention of the present application to couple the light signal from the dynamic optical fiber to the static optical fiber.

From the above published papers in the prior art, on the whole, it is found that there is no technique of light coupling from the dynamic optical fiber to the static optical fiber even if the technique of free space light coupling has been developed for many years. However, all these different techniques of free space light coupling shows that the technique of light coupling for the dynamic optical fiber indeed has the practicability.

In the U.S. Pat. No. 4,814,118 entitled “Method of molding a connector for optical fibers” by Plummer et al., a connector of optical fibers made by molding technique was disclosed. Through the elements like the round tube and the lens, the free space coupling light including the ruminant light and the receiving light is limited inside the round tube. The auxiliary lens are used for helping the free space coupling signal to be restrained inside the numeric aperture of the optical fiber. Presently, the re-productivity and the consistency of the connector element are maintained within a certain range, which means it is suitable for mass production Since the molding technique has made the alignment error of the connector very small, how to simplify the connector structure for easier operation has been always the purpose in the industry. Nevertheless, the technique and the device for coupling the dynamic optical fiber disclosed in the present invention possess the advantage and the practicability.

In the U.S. Pat. No. 5,745,620 entitled “Optical coupling” by Bergmann, a system for free space optical coupling was disclosed. The main function of the system is to prevent light radiation from entering the free space. When the light radiation is entering the free space, the light is transmitted to the receptacle to be received so that the efficiency of the light coupling is judged and under control. In other words, it is the compensative method for the signal loss. Furthermore, this method utilizes the complex machinery structure and does not have the technique of coupling light between the dynamic optical fiber and the static optical fiber.

In the U.S. Pat. No. 6,280,100 entitled “Fiber optic connector with microalignable sensing fiber and associated fabrication method” by Haake, a connector with microalignable sensing fiber was disclosed. It utilizes a connector housing with the input optical fiber and output optical fiber mounted respectively on both sides of the connector housing. Within the connector housing, a pair of optical lens are mounted for collimating the optical signals, and a micro-alignment sensing coupling fiber is mounted as well so that the accuracy of optical fiber alignment is raised. This patent has explained the necessity and the practicability of the mutual coupling among many optical fibers, only that it is still not the technique of coupling light between the dynamic optical fiber and the static optical fiber. Therefore, the patent is basically different from the present invention.

In view of the drawbacks in the prior art, a dynamic optical coupling device used in a free space is provided. The inventive device is able to solve the aligned problem of light coupling between dynamic optical fiber and static optical fiber so that the light coupling could be accomplished under the dynamic environment. The optical coupling device of the present invention could be applied not only to the automation equipment of the fiber-to-fiber manufacturing, but also to the automation manufacture of the active and passive elements in optical fiber communication. Thus, the purpose of accomplishing the dynamic light coupling and alignment in the free space could be achieved by the simplest method, technique, and material.

### SUMMARY OF THE INVENTION

The main purpose of the present invention is to provide a dynamic optical coupling device used in a free space, which is used for coupling the light signal in the automatic on-line examination system of optical fiber.

It is another object of the present invention to provide a dynamic optical coupling device used in a free space, which couples the light signal from the static and fixed optical fiber to the dynamic and rotational optical fiber.

According to one aspect of the present invention, a dynamic optical coupling device for coupling an optical signal from a static optical fiber to a dynamic optical fiber, includes: a static element for inputting the optical signal, a static ferrule adaptor for mounting the static element therein to pass therethrough, a dynamic element for outputting the optical signal, a dynamic ferrule adaptor for mounting the dynamic ferrule element therein to pass therethrough, wherein a free space is formed between the static ferrule adaptor and the dynamic ferrule adaptor, a ferrule adaptor connector for connecting the static ferrule adaptor and the dynamic ferrule adaptor, and a supporting frame mounting the ferrule adaptor connector therein.

In accordance with the present invention, the supporting frame further includes: a connection piece having a passing-through space for mounting the ferrule adaptor connector therein, and plural elastic elements having an end connected with the supporting frame and another end connected with the connection piece respectively for absorbing a vibration of the connection piece and three-dimensionally adjusting a position of the connection piece freely.

Preferably, the connection piece is a connection board.

Preferably, the plural elastic elements are springs for decreasing a vibration of the connection piece.

Preferably, the static element is a fixed optical fiber.

Preferably, the dynamic element is a rotating optical fiber.

Preferably, the ferrule adaptor connector is able to decrease an optical power loss caused by a lateral and angle deflection of the static element and the dynamic element and a coupling distance of the free space.

Preferably, the ferrule adaptor connector connects the static element and the dynamic element within the ferrule adaptor connector for coupling the optical signal from the static optical fiber to the dynamic optical fiber via the free space between the static ferrule adaptor and the dynamic ferrule adaptor.

Preferably, the supporting frame further includes a controlling knob for longitudinal adjustment, which is able to be adjusted automatically and dynamically in response to different coupling statuses.

Preferably, the supporting frame further includes a controlling knob for horizontal adjustment, which is able to be adjusted automatically and dynamically in response to different coupling statuses, and move the dynamic optical coupling device to a specific position.

Preferably, the supporting frame further includes a magnetic base for fixing a chassis.

Preferably, the index matching grease is added into the free space for increasing a light coupling efficiency.

The foregoing and other features and advantages of the present invention will be more clearly understood through the following descriptions with reference to the drawings, wherein:

### BRIEF DESCRIPTION OF THE DRAWINGS

FIGS. 1(a) and 1(b) are diagrams illustrating the control parameters according to a preferred embodiment of the present invention;

FIG. 2 is a front view according to a preferred embodiment of the present invention;

FIG. 3 is a lateral view according to a preferred embodiment of the present invention; and

FIG. 4 is a diagram comparing the calculational result and the experimental result of the longitudinal deflective loss under the situation of using the index matching grease and without using the index matching grease according to a preferred embodiment of the present invention;

### DETAILED DESCRIPTION OF THE PREFERRED EMBODIMENT

The present invention will now described more specifically with reference to the following embodiments. The device disclosed here is a dynamic optical coupling device which makes the light coupling accomplished in a free space of the dynamic environment. In order to overcome the numeric aperture limit for optical fiber alignment, the ferrule adaptor is used for reducing the coupling loss caused by the numeric aperture. Besides, the ferrule adaptor can also reduce the coupling loss caused by the lateral deflective alignment and the angular deflection. In order to align the test fibers rapidly, preferably, the detachable ferrule adaptor is utilized to pass through the dynamic optical fiber, and then pass through the device of the present invention together with the optical fiber connected with the fixed ferrule adaptor, so that the alignment between the dynamic optical fiber and the static optical fiber is accomplished and the purpose of coupling the light signal is achieved. Nevertheless, for the purpose of applying the present invention to the automation manufacture of fiber-to-fiber and coupling the light signal from the static optical fiber to the dynamic optical fiber, the frame structure for light coupling in the free space is provided, which has the features of vibration absorbing and free position adjustment three-dimensionally. Preferably, the free space dynamic optical coupling device is able to be mounted on the automation equipment of fiber-to fiber manufacture.

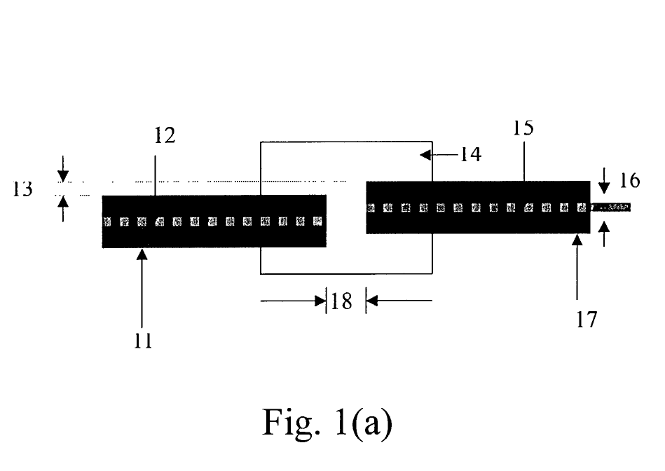

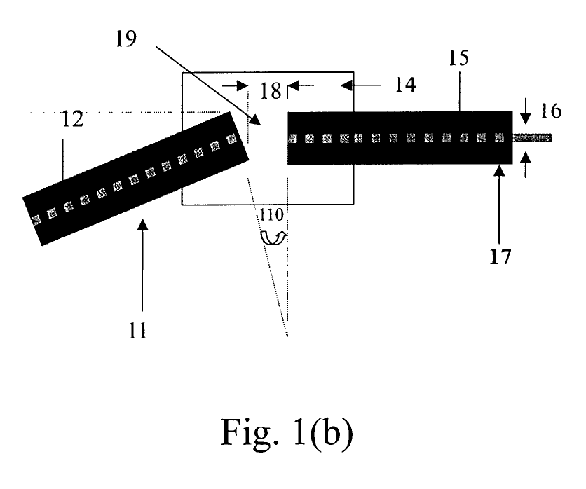

Please refer to FIGS. 1(a) and 1(b). FIGS. 1(a) and 1(b) are diagrams illustrating the control parameters according to a preferred embodiment of the present invention. The main system, elements, and control parameters include the static ferrule adaptor 11, the static optical fiber 12, the lateral deflection of optical coupling 13, ferrule adaptor connector 14, the dynamic optical fiber 15, the diameter 16 of the fiber cladding, the dynamic ferrule adaptor 17, the longitudinal offset 18 of optical coupling, the index matching grease 19, and the angular deflection 110 of optical coupling. Since the static ferrule adaptor 11 and the dynamic ferrule adaptor 17 are utilized, the control parameters including the lateral deflection of optical coupling 13, the longitudinal offset 18 of optical coupling, and the angular deflection 110 of optical coupling, are able to be improved.

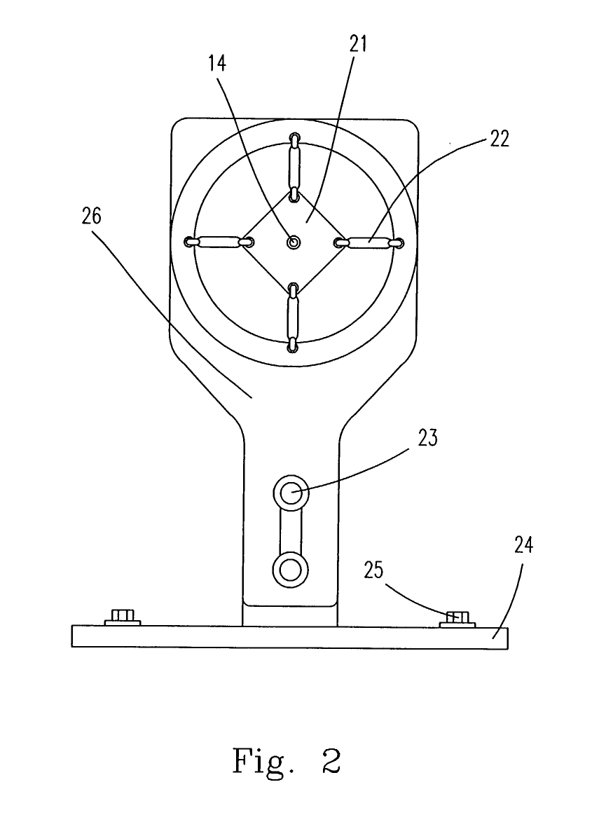

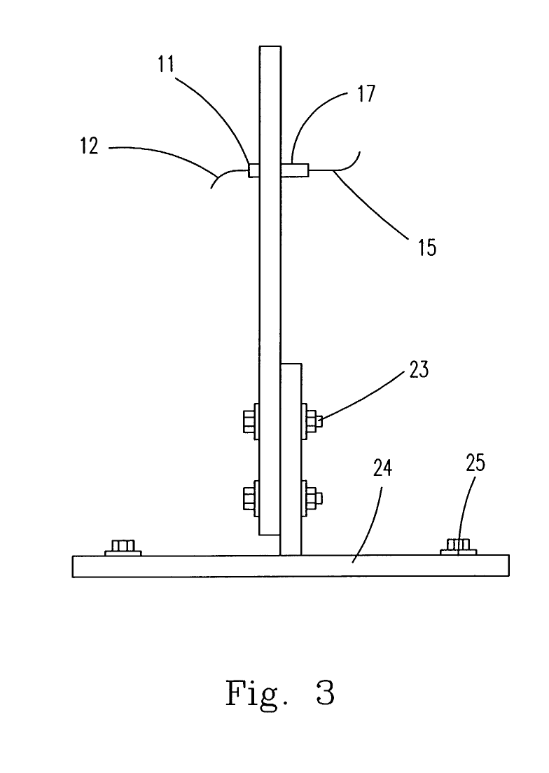

Please refer to FIG. 2. FIG. 2 is a front view according to a preferred embodiment of the present invention. The structure includes the ferrule adaptor connector 14, the connection board 21, the spring 22, the controlling knob for longitudinal adjustment 23, the controlling knob for horizontal adjustment 25, the supporting frame 26, and the magnetic base 24 for fixing the chassis. There are four of springs 22, which are able to minimize the vibration caused by the eccentric and imbalance running of the rotational movement of the optical fiber. The controlling knob for longitudinal adjustment 23 is able to be adjusted automatically and dynamically in response to different coupling statuses. The controlling knob for horizontal adjustment 25 is able to be adjusted automatically and dynamically in response to different coupling statuses, and it could also move the dynamic optical coupling device to a best position for optical coupling. The magnetic base 24 is used for fixing the chassis.

In order to verify the identity between the theoretical result and the experimental result and the reliability for application as well, the practical apparatus is used for testing and collecting the information. The relationship between the longitudinal offset of optical coupling and the light coupling loss, which is generated under the different combinations of different control parameters, is analyzed. It is known from the result that the present invention has the applicable reliability.

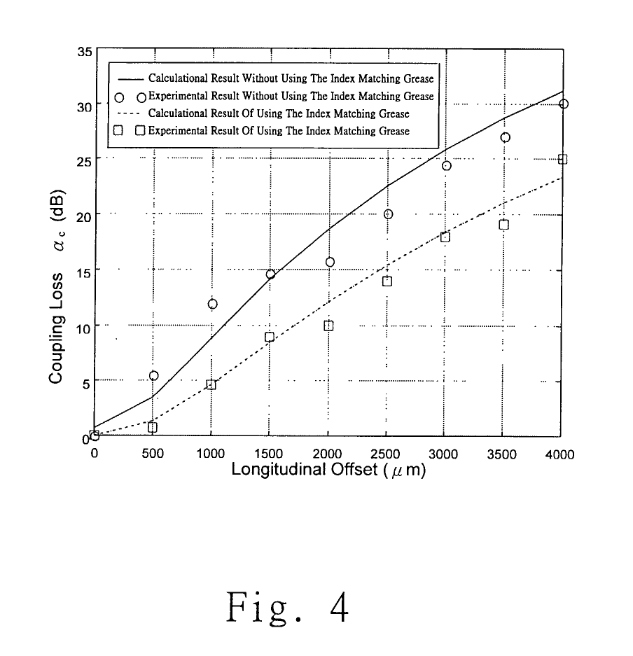

First of all, the control parameters of optical coupling, including the lateral deflection of optical coupling 13, the longitudinal offset 18 of optical coupling, and the angular deflection 110 of optical coupling in FIGS. 1(a) and 1(b), are regards as the controlling factors in the free space dynamic optical device. The calibration of the free space dynamic optical device is accomplished by the frame structure in FIG. 2. The ferrule adaptor connector 14 will reduce the coupling loss caused by the lateral deflection of optical coupling 13 and the angular deflection 110 of optical coupling. Therefore, the ferrule adaptor connector 14 including the static ferrule adaptor 11, the static optical fiber 12, the dynamic optical fiber 15, the diameter 16 of the fiber cladding, and the dynamic ferrule adaptor 17, are used here. The light source is added from the end of the static optical fiber. After passing through the rotational optical fiber and another set of the free space dynamic optical device, the light is intercepted at the end of the static optical fiber. The experimental result and the calculating result are respectively obtained as shown in FIG. 4. It is known from the FIG. 4 that the experimental result is in agreement with the theoretical result after adding the index matching grease. Meantime, the purpose of dynamic coupling in the free space is achieved. The light coupling loss is crucially affected by the adjustment of the longitudinal offset 18 of optical coupling, also, crucially affected by whether the matching grease is added into the free space of optical coupling.

The characteristics of the present invention is that the factors for light coupling loss including the longitudinal offset of alignment, the lateral deflection of alignment, and the angular deflection of alignment, are minimized through the simple element combination so that the affect of the light coupling loss could be minimized as well. The elements used in the device here are simple, cheap, easy to obtain and handle. Furthermore, the elements could be applied to the system for the free space dynamic optical coupling, for example, the automation equipment of fiber-to-fiber manufacture, the optical alignment of the active and the passive elements in optical communication, and on-line automatic production.

The free space dynamic coupling device of the present invention is accomplished through the frame of the simple elements by the cooperation of the special design and the on-line system. The light coupling could be accomplished without the complex and expensive optical elements. Through the quakeproof frame and the flat platform, the aligned difference between the static optical fiber and the rotational optical fiber is overcome. In the respect of the on-line manufacturing equipment and the interference of mechanical vibration with the same vibration frequency, the difficulties are conquered as well. The detachable adaptor of optical fiber makes the combination of the optical fiber and the adaptor accomplished instantaneously in the on-line system. Since the present invention is established under the base of optics, mechanics, and the geometry, it is therefore able to be used in the dynamic optical coupling of the active and passive elements, the on-line examination, and the system of the active and passive automatic alignment. Thus, the present invention provides large improvement for the production automation of the active and the passive elements in optical communication, and the aligned system of the active and the passive alignment. In conclusion, the present invention improves the drawbacks in the prior art and has the industrial value.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A dynamic optical coupling device for coupling an optical signal from a static optical fiber to a dynamic optical fiber, comprising:
a static element for inputting said optical signal;
a static ferrule adaptor for mounting said static element therein to pass therethrough;
a dynamic element for outputting said optical signal;
a dynamic ferrule adaptor for mounting said dynamic ferrule element therein to pass therethrough, wherein a free space is formed between said static ferrule adaptor and said dynamic ferrule adaptor;
a ferrule adaptor connector for connecting said static ferrule adaptor and said dynamic ferrule adaptor; and
a supporting frame mounting said ferrule adaptor connector therein.

2. The dynamic optical coupling device according to claim 1, wherein said supporting frame further includes:
a connection piece having a passing-through space for mounting said ferrule adaptor connector therein; and
plural elastic elements having an end connected with said supporting frame and another end connected with said connection piece respectively for absorbing a vibration of said connection piece and three-dimensionally adjusting a position of said connection piece freely.

3. The dynamic optical coupling device according to claim 2, wherein said connection piece is a connection board.

4. The dynamic optical coupling device according to claim 2, wherein said plural elastic elements are springs for decreasing a vibration of said connection piece.

5. The dynamic optical coupling device according to claim 1, wherein said static element is a fixed optical fiber.

6. The dynamic optical coupling device according to claim 1, wherein said dynamic element is a rotating optical fiber.

7. The dynamic optical coupling device according to claim 1, wherein said ferrule adaptor connector is able to decrease an optical power loss caused by a lateral and angle deflection of said static element and said dynamic element and a coupling distance of said free space.

8. The dynamic optical coupling device according to claim 1, wherein said ferrule adaptor connector connects said static element and said dynamic element within said ferrule adaptor connector for coupling said optical signal from said static optical fiber to said dynamic optical fiber via said free space between said static ferrule adaptor and said dynamic ferrule adaptor.

9. The dynamic optical coupling device according to claim 1, wherein said supporting frame further includes a controlling knob for longitudinal adjustment, which is able to be adjusted automatically and dynamically in response to different coupling statuses.

10. The dynamic optical coupling device according to claim 1, wherein said supporting frame further includes a controlling knob for horizontal adjustment, which is able to be adjusted automatically and dynamically in response to different coupling statuses, and move said dynamic optical coupling device to a specific position.

11. The dynamic optical coupling device according to claim 1, wherein said supporting frame further includes a magnetic base for fixing a chassis.

12. The dynamic optical coupling device according to claim 1, wherein an index matching grease is added into said free space for increasing a light coupling efficiency.
